(19) United States
(12) Patent Application Publication
(10) Pub. No.: US 2023/0107944 A1
(43) Pub. Date: Apr. 6, 2023

(54) SYSTEMS AND METHODS FOR CONVERSATIONAL ORDERING

(71) Applicant: KATAPAL, INC., Boston, MA (US)

(72) Inventors: David Y. XIAO, Boston, MA (US); Christopher D. BELAND, Somerville, MA (US)

(73) Assignee: KATAPAL, INC., Boston, MA (US)

(21) Appl. No.: 17/907,196

(22) PCT Filed: May 6, 2021
(86) PCT No.: PCT/US2021/031036

§ 371 Date: Sep. 23, 2022

Related U.S. Application Data
(60) Provisional application No. 63/021,734, filed on May 8, 2020.

(51) Int. Cl. G10L 15/18; G10L 15/16; G06F 40/205

(52) U.S. Cl. CPC G10L 15/1822; G06F 40/205; G10L 15/16

(57) ABSTRACT

A system for generating a response to an unstructured natural language utterance is disclosed. The system can include a device configured to receive an unstructured natural language utterance; an interpretation module configured to process the unstructured natural language utterance via a machine learning algorithm and a rule-based parser; a reconciliation module configured to reconcile outputs of the machine learning algorithm and the rule-based parser to obtain structured features; and a response module configured to process the structured features using context information and known data to generate a response to the unstructured natural language utterance.

### FIELD

The present disclosure relates to systems and methods for conversational ordering.

### RELATED APPLICATIONS

This application is a U.S. National Stage Application of International Application No. PCT/US2021/031036, filed May 6, 2021, which claims priority to U.S. Provisional Pat. Application No. 63/021,734 “Systems and Methods for Conversational Ordering” filed on May 8, 2020. Each of the foregoing are hereby incorporated herein by reference in their entireties.

### BACKGROUND

Known solutions for creating conversational ordering systems start out generic and are either unable to handle the specifics of a particular merchant or require significant manual intervention to train a custom natural language model capable of understanding requests specific to that merchant.

To automate such a process by transforming input unstructured natural language utterances into structured features presents a challenge because the natural language utterances to be processed may contain vocabulary specific to a particular merchant, so one size does not fit all. This challenge can be overcome by a machine learning process as described in in the present disclosure.

To apply a machine learning algorithm effectively, it must be trained by running a training algorithm on “labeled examples”, namely a set of examples of inputs and desired outputs. Obtaining labeled examples is a costly problem because the naive way to do it would be to obtain a set of inputs, in our case user utterances, and having a person manually annotate them with the intent, entity list, and dependency parse.

Obtaining the user utterances may be costly, as it requires obtaining transcripts of many user conversations, while annotation is even more expensive because it requires a certain amount of skill that needs to be taught to the human annotator. This becomes even more difficult if the annotations must be customized for vocabulary specific to a single merchant.

Creating utterance templates can be time-consuming as it requires finding examples of real user utterances and generating templates from them. Manually creating hand-crafted dependency parse graphs for each the utterance templates would make this process even more expensive.

To overcome the aforementioned technical challenges, the present disclosure provides technical solutions that are agnostic to the specific implementation of the machine learning algorithm.

### SUMMARY

A system for generating a response to an unstructured natural language utterance is disclosed. The system can include a device configured to receive an unstructured natural language utterance; an interpretation module configured to process the unstructured natural language utterance via a machine learning algorithm and a rule-based parser; a reconciliation module configured to reconcile outputs of the machine learning algorithm and the rule-based parser to obtain structured features; and a response module configured to process the structured features using context information and known data to generate a response to the unstructured natural language utterance.

In exemplary embodiments, the device can be configured to receive the unstructured natural language utterance over an audio communication channel or a text communication channel. The machine learning algorithm can be a neural network. The machine learning algorithm is trained on menu data and utterance templates.

In exemplary embodiments, the output of the machine learning algorithm may include an intent of the unstructured natural language utterance, an entity list that provides information regarding the entities involved in the unstructured natural language utterance, and a dependency graph that provides a relationship between words of the unstructured natural language utterance.

In exemplary embodiments, the rule-based parser can be configured to use hard-coded rules specific to a merchant associated with the device. To process the structured features the response module can be configured to search menu data for an entry matching entity in the structured features. The response module can be configured to resolve ambiguities in the entry. The response module can be configured to perform a task associated with the entry. The response can be in natural language.

A computer-implemented method for generating a response to an unstructured natural language utterance is disclosed. The method can include receiving an unstructured natural language utterance; processing the unstructured natural language utterance via a machine learning algorithm and a rule-based parser; reconciling outputs of the machine learning algorithm and the rule-based parser to obtain structured features; and processing the structured features using context information and known data to generate a response to the unstructured natural language utterance.

### BRIEF DESCRIPTION OF DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows a system for generating a response to an unstructured natural language utterance according to an exemplary embodiment of the present disclosure;

FIG. 2 shows a flowchart for training a natural language model using automated labeled example generation algorithm according to an exemplary embodiment of the present disclosure;

FIG. 3 shows a flowchart for generating a response to an unstructured natural language utterance according to an exemplary embodiment of the present disclosure; and

FIG. 4 illustrates an exemplary machine configured to perform computing operations according to an embodiment of the present disclosure.

### DESCRIPTION

The present disclosure describes conversational ordering systems and methods that may allow consumers to place orders on a conversational interface (e.g. telephone, messaging, etc.) simply by speaking or typing their order in plain English or another natural language. Aspects of the present disclosure describe a machine learning pipeline to train a model specific to the merchant’s menu or catalogue such that the resulting machine learning model can understand the vocabulary pertaining to that merchant, including available items, prices, etc.

Aspects of the present disclosure can be useful for streamlining orders (e.g. purchase orders), improving labor efficiency and reducing costs for businesses/merchants (e.g. restaurants) that rely on human employees to take orders. This is because such businesses/merchants, employees may answer over hundreds phone calls per day placing orders, which creates a large labor expense for the restaurant.

Aspects of the present disclosure provide a novel and non-obvious conversational ordering system that customizes its conversational interface to consider the specifics of each merchant, such as names of items, validation rules for ensuring orders can actually be processed as the user requested, price information, and more. The disclosed system/method provides a way to leverage a merchant’s menu/catalogue to automatically train a custom natural language model, reducing cost and saving time, and also accelerating repeat visits using information saved about every order.

In various exemplary embodiments, users can access the disclosed system through a variety of channels, such as a telephone call, SMS, over-the-top (OTT) messaging services like WhatsApp or Facebook Messenger, voice assistants such as Amazon Alexa or Google Assistant, in-store kiosks, and more.

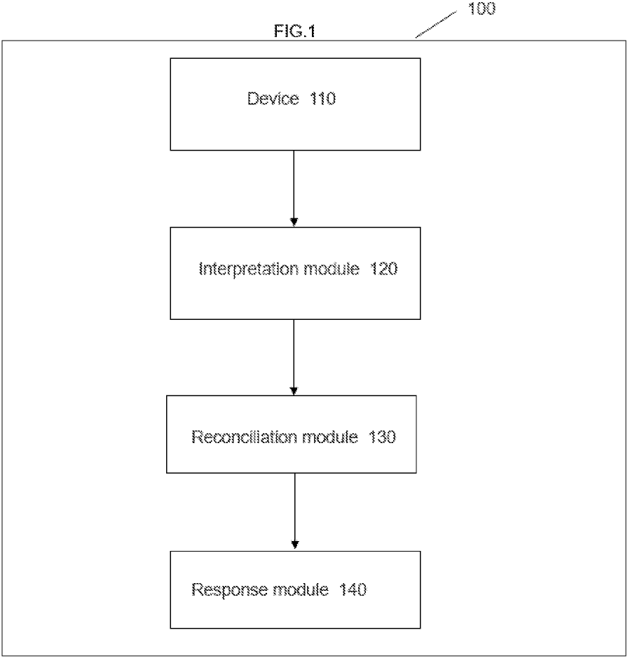

FIG. 1 shows an exemplary flow diagram for a system 100 for transforming unstructured natural language utterances into structured features. The system 100 may include a device 110 (e.g. a phone, pager, tablet, computer, processor, etc.) configured to receive unstructured natural language utterances via the various channels. These utterances can include questions such as “Are you open today?” or “Can I order a large pizza with mushrooms and green onions” to place a pizza order at a restaurant.

In an exemplary embodiment, the utterances can be received from various sources such as a human user, pre-recorded voice from a computer program etc. The device 110 may include an automated speech recognition (ASR) technology to answer the call and respond to the unstructured natural language utterances. For example, the device 110 may greet the user with a welcome message such as, “Hello, thanks for calling. I can help answer your questions or take your order. What would you like?”. The ASR may also transcribe the utterances into text.

A person of ordinary skill in the art would appreciate that the system 100 can operate with any number and types of natural language utterances. For example, the system 100 can support the following exemplary commands/requests/utterances: add, remove or modify items in their shopping cart; inquire about items in the menu/catalogue, such as ingredients or price; searching for items in the menu, including by category, name, or other features; inquire about the merchant, such as hours and location; inquire about the status of their current order, including the contents of their cart and the price; inquire about the status of previous orders; entering payment information; entering address, phone number, or other contact information; responding to questions; asking to speak to a human representative. This list is non-exhaustive, and implementations may use the techniques disclosed in the present disclosure to support other similar commands.

The system may include 100 an interpretation module 120 configured to process the unstructured natural language utterances via a machine learning algorithm and a rule-based parser. The two-pronged approach provides the best of both techniques. The machine learning algorithm can be flexible and handle examples with deviations in spelling or wording, but it can be unreliable in some cases. On the other hand, a rule-based approach can be rigid and get most cases right most of the time but tends to err on cases with unanticipated differences in spelling or word order.

The machine learning algorithm (e.g. neural networks, support vector machines, Bayesian methods, etc.) can be trained using input/output examples describing the transformation the machine learning algorithm is to implement. The rule-based parser where domain knowledge is used about the merchant to enforce outputs in the event that the machine learning algorithm performs unexpectedly. Both these approaches are described in detail in the disclosure. While the machine learning approach is described in detail with respect to neural network, other machine learning algorithms can also be similarly used.

In an exemplary embodiment, the interpretation module 120 may apply machine learning algorithms on the unstructured natural language utterances such as intent detection, entity recognition, and dependency parsing of the utterance. Each of these are described in detail using an exemplary utterance.

The intent of an utterance may indicate the overall nature/intent of the utterance. For example, for an utterance “Can I order a large pizza with mushroom and green onions”, the interpretation module 120 may output the overall intent as “add to cart”, indicating that the intent is to add an item to the shopping cart. Similarly, for an utterance “What time do you close”, the interpretation module 120 may output the overall intent as “tell me the hours”, indicating that the intent is to know the store hours at a restaurant/store setting.

The entity list may describe the nouns that the utterance operates on. For example, in the “add to cart” intent, the entities may be the items the user wishes to add: “pizza” is marked as an item entity from the menu and “large”, “mushroom”, and “green onions” are marked as option entities from the menu, as shown below. [image] Similarly, in an utterance such as “What time does your store at 300 Broadway close?” expressing the “tell me the hours” intent, the entity list may include the “300 Broadway” as an address entity identifying the location the user is asking about.

The dependency parse may provide dependency information that describes relationships between the words of the utterance. The dependency parse can be illustrated by a graph with labeled directed edges that describes how the different words relate to each other. For example, in the utterance “Can I order a large pizza with mushroom and green onions”, “large” can be the child of “pizza” and the relation can be labeled “amod”, indicating that “large” is an adjective modifying “pizza”.

The dependency parse shown below shows that “large” is an adjective that modifies “pizza” (label amod), “mushroom” is a prepositional object (label pobj) that is associated with “pizza” via the preposition (label prep) “with”, and “green onions” is associated as a conjunction (label conj) with “mushroom” via the coordination conjunction (label cc).

[image]

The output generated by the interpretation module 120 is not limited to overall intent, entity list and dependency parse. The output may include other features as well, for example, combining the entity list and dependency parse into a single feature set where the labels include information about the entity type. The next few paragraphs provide additional examples of unstructured natural language utterances input being processed by the interpretation module 120.

Input: “Replace the mushroom with pepperoni”. Output: Intent: “replace”; Output: Entity list: [image] Output: Dependency parse:

[image]

Input: “When are you open”. Output: Intent: “hours”; Entity list: (empty, no entities detected); Dependency parse:

[image]

The machine learning algorithm used by the interpretation module 120 may be trained to compute a desired a function. The training process can be performed by running a training algorithm on “labeled examples”, namely a set of examples of inputs and desired outputs. Described as follows is an illustration for automated labeled example generation for training the machine learning algorithm by taking two inputs: menu/catalogue data from a restaurant, and a set of utterance templates in a restaurant context.

### Menu Data

Menu data can be structured, with entries representing various entities and relationships between them. This structure can be used to ensure that the utterances generated cohere with the menu. For example, a menu may contain entries for “categories”, “items”, “options”, and “option groups” such that: each category may contain a list of items - category “Pizza” may contain “Cheese Pizza”, “Hawaiian Pizza”, and “White Pizza”; each item may contain a list of option groups - “Cheese Pizza” may contain option groups “Size” and “Toppings”; each option group contains a list of options - the option group “Size” may contain “Small”, “Medium”, and “Large”, and the “Toppings” option group may contain “Pepperoni”, “Mushroom”, and “Onion”. This menu structure can be represented many ways, such as using a list of JSON objects or a collection of SQL tables. The example generation does not depend on the representation chosen.

Similarly, other variations to structure a menu may include but are not limited to: having multiple nested levels of categories, for example top level categories “Breakfast Menu” and “Lunch Menu”, where each top level category contains sub-categories; multiple nested levels of options, for example where each entry in “Topping” contains a nested option group “Placement” that can take value “Left half”, “Right half”, “Everywhere” indicating where to place the topping, and a nested option group “Amount” that can take values “Lite”, “Regular”, “Extra”. Menu data is not restricted to food but can also contain data about other types of items.

In an exemplary embodiment, in addition to entities and the relationships between them, menu data may contain other information such as constraints (e.g. one selection is required for “Size” and no more than one selection is allowed for “Size”), pricing, description, ingredients, and more. Menu data may also include linguistic data such as synonyms, so that for example “Cheese Pizza”, “Hawaiian Pizza”, and “White Pizza” all match the synonym “Pizza”, which may refer to any of these.

### Utterance Templates

An utterance template can be a string of text that represents both literal text and variables, along with an associated intent. For example: “Can I order a @items_to_add” [Intent: add_to_cart]. This template contains a variable @items_to_add, which can be expanded during the labeled example generation process. This is illustrated in the next few paragraphs with one specific example set of expansion rules, which illustrates key features of expansion rules, which may then be defined appropriately for other cases.

Each variable can have a set of rules that define how it can be expanded, and variables that can be chained together. For example, to define @items_to_add as a variable that can expand into a list of items each possibly with options, @items_to_add can be defined to expand to a list of @single _item_ to _add, where the length of the list is described by a probability distribution, such as 1 with probability ½, 2 with probability ¼, and 3 with probability ¼.

Similarly, @single_item_to_add can be defined to expand a random quantity, for example 1 with probability ½ and 2 with probability ½ a randomly chosen item from the set of all items described in the menu data, a list of randomly chosen @option_group_for_item variables for option groups that are related to the item as described in the menu data section: where the length of list of is described by a probability distribution, such as 0 with probability ½, 1 with probability ¼, and 2 with probability ¼.

Likewise, @option_group_for_item can be defined to expand to a list of randomly chosen option entities for options that are related to the option group as previously described, with the length of the list described by a probability distribution, such as 1 with probability ⅓, 2 with probability ⅓, and 3 with probability ⅓.

In addition, the expansion rules describe how to label the resulting data. These expansion rules can be applied with menu data by expanding @items_to_add to two @single_item_to_add entries. The first @single_item_to_add entry can expand to the quantity 1 and an item “Cheese Pizza” with 1 @option_group_for_item “Toppings”, and two option entries can be selected from the “Toppings” item group, such as “Pepperoni” and “Mushroom”. The second @single_item_to_add may expand to the quantity 1 and an item “White Pizza” with 1 @option_group_for_item “Size”, which can be selected to 1 option “Large”. The resulting output can be “Cheese Pizza” with “Pepperoni” and “Mushroom” as options for the “Toppings” option group, and “White Pizza” with “Large” as an option for the “Size” option group.

Such an expansion process can be probabilistic and shows one of the many ways the expansion process might play out given the rules of the above example. Because of this randomness, running the same expansion twice may produce different results. This can be essential to produce a diverse set of examples. The probability distributions that define this random process can be defined on a case-by-case basis depending on domain knowledge about the menu data, though there may be defaults that serve as fallbacks. Frequently used defaults may include selecting a uniformly random item from a category or a uniformly random option group from all option groups related to an item or using truncated exponential distributions to select the number of options from an option group.

In an exemplary embodiment, the rules that govern expansion may be overridden or modified based on constraints that the menu data imposes. For example, the option group “Size” may have a constraint that says exactly one selection is valid and no more than one is allowed. This may be taken into account in the expansion process, changing the probability distribution used to sample the option.

The output of the expansion rules must be output in natural language. For example, in the expansion rule example above, the output was “Cheese Pizza” with “Pepperoni” and “Mushroom” as options for the “Toppings” option group, and “White Pizza” with “Large” as an option for the “Size” option group. This may be output as: “cheese pizza with pepperoni and mushroom and large white pizza”.

Such an output can be constructed using the following rules: “Pepperoni” and “Mushroom” are associated with “Cheese Pizza” using the preposition “with”; they are first combined into a list “pepperoni and mushroom” and then attached to “cheese pizza” with “with” “Large” is associated with “White Pizza” as an adjective; the two resulting items “cheese pizza with pepperoni and mushroom” and “large white pizza” are combined in a list using “and”. The output can be constructed by choosing the correct connecting structure, which may be a preposition “with” as with “Pepperoni” and “Mushroom” above, or by placement as an adjective as with “Large” above.

These are some simple examples of connecting structures; other connecting structures may include other prepositions, other word orders, etc. The choice of connecting structure can be annotated in the menu data itself, can be manually added to the menu data prior to example generation, or can be automatically generated using domain knowledge about the menu.

To generate labeled examples as part of the automated example generation process, the expansion rules should include instructions for labeling the expanded terms. As such, the previously described expansion example of the utterance template “Can I order a @items_to_add” [Intent: add_to_cart] can be refined. First, the output of the expansion may include the intent “add_to_cart”. In addition, expansion rules may specify that the items will be labeled as an item entity and options will be labeled as an option entity.

A dependency graph for linking the options to items can then be generated. This can also depend on how the generated entities are output into natural language, including any auxiliary words such as prepositions. The dependency graphs can be built using pre-set rules that govern how natural language constructions such as attaching options to items via certain prepositions and combining items together in a list. Shown below are exemplary dependency graphs for this expansion example.

[image]

These dependency graphs can then combine with the entire utterance to produce the overall dependency graph. The dependency arcs for words outside of the expanded variables should also be specified. There are several ways to do this. They may be either hard-coded into the utterance template itself, for example the utterance template may include a dependency parse such as:

[image]

Then, the variable expansion can be substituted into this expression to obtain the overall result, shown below:

[image]

The dependency arcs for words outside of the expanded variables may also be obtained by running a generic pre-trained dependency model on the utterance prior to expansion of variables, then inserting the expansion and its dependency graph. In a pre-trained dependency model, a dependency parser algorithm may exist prior to running the automated labeled example generation algorithm. Such pre-trained dependency models may be obtained from standard packages like NLTK (Natural Language Toolkit) or may be built specifically for use in automated labeled example generation.

To use a pre-trained model to build a dependency parse graph, the original utterance template can be substituted in the root word of the expansion. Then the pre-trained dependency model can be run on the resulting partially substituted utterance, and then substituted back in the entire variable expansion. In the expansion example for “can I order @items_to_add” with “1 cheese pizza with pepperoni and mushroom and 1 large white pizza”, the substitution of the root word of the expansion into the utterance template would result in “can I order pizza”. The pre-trained dependency model would be run on the result to obtain:

[image]

This would then be then substituted back in the entire variable expansion to obtain the below dependency graph. An annotation of the dependency graph can reliably and scalably be computed for all automatically generated examples.

[image]

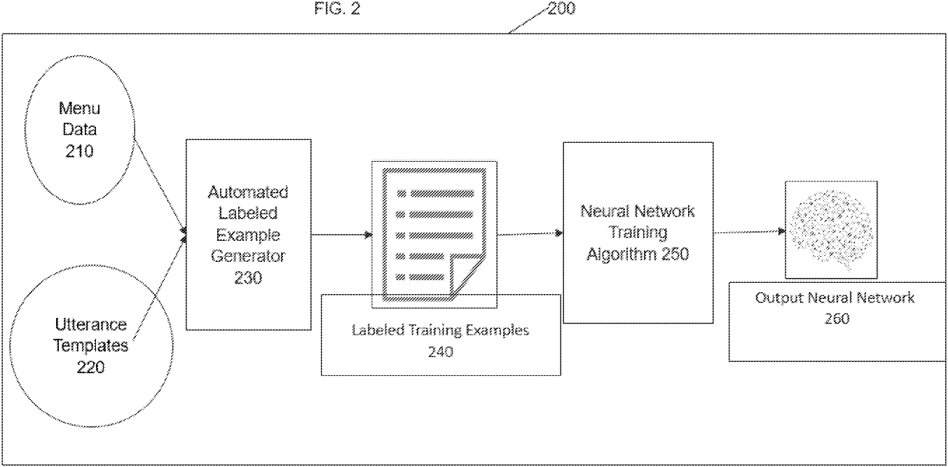

FIG. 2 shows a flowchart 200 for training a natural language model using the automated labeled example generation algorithm for a set of menu data 210 and a list of utterance templates 220. Aspects of the menu data 210 and utterance templates 220 can be similar to the menu data and utterance templates described previously in the present disclosure.

The menu data 210 and utterance templates 220 are used by the automated labeled example generator 230 to create labeled training examples 240 by a process described previously in the present disclosure. Once a desired number of labeled examples have been obtained, the labeled examples 240 can be fed to the neural network training algorithm 250 to generate an output 260. The desired number of labeled examples 240 may depend on the application and can be tuned based on performance of the resulting models. The next few paragraphs described the rule-based parser that is used by the interpretation module 120 in addition to the machine learning algorithm.

In an exemplary embodiment, the rule-based parser by the interpretation module 120 can be used with explicit hard-coded rules. These rules may rely on the menu data to customize the rules to be specific to a single merchant. For example, the interpretation module 120 may search the input for strings that are substrings of names of entities in the menu data. In the utterance “can I order a large pizza”, the rule-based parser can identify that “large” matches an option “Large” in the Menu Data, and “pizza” matches items “Cheese Pizza”, “Hawaiian Pizza” and “White Pizza”, and would return these as possible matches. The rule-based parser can search not just for substrings but also use standard techniques such as stemming and lemmatization to search for variants of the names of entities, as well as searching for approximate matches using metrics such as edit distance.

The system 100 may include a reconciliation module 130 configured to reconcile outputs of the interpretation module 120 to obtain structured features. As previously described, when given a natural language utterance, the interpretation module 120 applies a machine learning algorithm and rule-based parser on the utterance to produce outputs such as intent, entity list, and dependency graph. In some cases, the outputs of the machine learning algorithm and the rule-based parser may be different from each other. In such cases, reconciliation of the outputs becomes significant to the operation of system 100, as described in the following paragraphs.

For an Input: “Can I order a large pizza with mushroom and green onions”, the entity list output of a machine learning algorithm (neural network) can be as follows.

[image]

For the same input, the output of a rule-based parser can be as follows.

[image]

That is, in this example, the entity lists differ in the outputs of the machine learning algorithm and rule-based parser. The machine learning algorithm does not label “large” as an entity, while the rule-based parser correctly labels it as MENU_OPT (an option). The neural network labels “mushroom” as an option and the rule-based parser labels it as an item. The neural networks labels “green onions” as an option, while the rule-based parser labels just “onions” as an option, excluding the word “green”.

The output of the neural network and rule-based parser can be reconciled by applying heuristics. This can be done by including all entities produced by either the neural network or rule-based parser that do not intersect another entity; including all entities that cover the same span of text for deferred disambiguation, as described later in the present disclosure. For entities that overlap other entities, longer matches could take precedence, e.g. in the above example “green onions” should take precedence over just “onions”.

Applying these heuristics to the example above can provide an entity list with “large” labeled as an option entity, “pizza” labeled as an item entity, “mushroom” labeled ambiguously as both an option entity and an item entity, and “green onions” labeled as an option. Other rules may be suitable depending on the particular menu data and use case in question.

The system 100 may include a response module 140 configured to process the structured features using context information and known data to generate a response. At a high level, the response module 140 can operate in the following stages: resolution, disambiguation, execution, and response generation.

Each of these stages are described in detail with respect to the example utterance “Can I order a large pizza with mushroom and green onions”, with the intent “add to cart”; entity list: [image] where “Mushroom” is ambiguous, and may be either an option or an item; and dependency parse:

[image]

As part of the resolution stage, the response module 140 may be configured to search the menu data for entries matching the entities in the structured features provided by the reconciliation module 130. The search may successfully find entries for “large” as an option, “pizza” as an item, “mushroom” as an option, “mushroom” as a match for the item “mushroom risotto” and “green onions” as an option. The response module 140 may assign a quality score to each match; for example “large” is an exact match for an option named “large”, and it may be assigned the best quality of 0 (lower is better, 0 is best), while “mushroom” is only an approximate match for “mushroom risotto” and it may be assigned a match quality of 1. The exact definition of match quality can depend on how the menu data is set up and a level of granularity.

The response module 140 may then use the dependency graph in features to associate the entities with each other. The dependency graph can show that “large” is a child of “pizza”, “mushroom” is a child of “pizza”, and “green onions” is a child of “mushroom” which is a child of “pizza”. These relationships dictate how the options are related to items: each option is related to its closest ancestor that is an item.

In the case that “mushroom” is an option, then “large”, “mushroom”, and “green onions” are all descendants of “pizza”, so in this case it can be checked whether they are valid options for “pizza” in the menu data. In this case that “green onions” is not a valid option for “pizza”, but “large” and “mushroom” are valid options for “pizza”.

In the case that “mushroom” is a match for an item “mushroom risotto”, then “large” is a child of “pizza” and “green onions” is a descendent of the “mushroom risotto” item, so it is checked whether “large” is a valid option for “pizza” in the menu data and whether “green onions” is a valid option for the “mushroom risotto” item. For this example, “green onions” may not be a valid option for “mushroom risotto”, but “large” may be a valid option for “pizza”.

An option that does not have an ancestor that is an item that it is a valid option for according to the menu data is considered orphaned. In this example, “green onions” is an orphaned option in both of the above alternatives. Resolution will return two alternatives that will have to be disambiguated, one for each of the above cases: an item “pizza” that has options “large” and “mushroom” and an orphaned option “green onions”; and an item “pizza” that has option “large”, an item “mushroom risotto”, and an orphaned option “green onions”.

In an exemplary embodiment, the resolution by the response module 140 may fail, e.g. if the utterance had asked for “tulips” on their “pizza” and there is no entry for “tulips” in the menu, the output of resolution will output an error that it could not find “tulips” in the menu data, and the downstream response generation stage may generate a response advising of this issue.

As noted previously, there may be ambiguity in the output of the resolution. In such cases, as part of the disambiguation stage, the response module 140 may use context and other heuristics to select the correct alternative. The output of the disambiguation of the two alternatives provided by the resolution stage noted above would be “An item “pizza” that has options “large” and “mushroom” and an orphaned option “green onions″”. The steps/rules to reach this output are described in detail as follows.

Rule 1 - a response with the type expected by a question is preferred. For example, for a question “What kind of toppings do you want?”, which expects an answer that is an option that is a topping, or a question “What kind of pizza would you like”, which expects an answer that is an item. In these cases, alternatives that match the respective expectation are preferred. Rule 2 - higher-quality matches are preferred. For example, the match “mushroom” for an option named “mushroom” is an exact match and thus higher quality than the match “mushroom” for an item named “mushroom risotto”, and so the “mushroom” option is preferred. Rule 3 - alternatives that are in valid relationships to each other are preferred. For example, “mushroom” as an option related to “pizza” according to the dependency graph over “mushroom risotto” as an independent item is preferred.

Applying these rules, the second and third rules both favor choosing the alternative where “mushroom” is an option related to “pizza” over the alternative where “mushroom” represents the item “mushroom risotto”. If applying all of the disambiguation rules does not result in a unique output, the disambiguation stage can produce as an error that may require the response module 140 to prompt the user to select from among the various alternatives that it found. The order of precedence of these rules may be adjusted on a case-by-case basis. Additional similar rules for disambiguation may be incorporated.

In the execution stage, a task requested by the user/utterance is performed. In the previously noted example, the intent of the utterance was “add to cart” and the output of disambiguation is an item “pizza” with options “large” and “mushroom” and an orphaned option “green onions”. For this request, execution can add the item “pizza” with the options “large” and “mushroom” to the shopping cart. The state of the shopping cart can be maintained by of the ordering backend, discussed in detail below. The attempt to add an item may succeed, or the ordering backend may return an error, for example if the user makes an invalid request like “pizza” with options “large” and “small”.

The ordering backend can manage the shopping cart, and other standard parts of a commerce experience. This includes maintaining shopping cart - remember the items that have been ordered. It further includes validation - specify validation rules, for example a “pizza” item must have exactly one choice for its “size” option group. If the user adds a “pizza” without a size or a “pizza” with both “small” and “large” options, then this should result in an error that should be relayed to the user. It further includes payment: to complete checkout, user may be required to pay their order using their credit card or other payment method. The ordering backend can support processing payments for the various payment methods the merchant supports. This may require, for instance, taking the user’s credit card number. The ordering backend may further provide dispatch functionality such that the order must be sent to the merchant for fulfillment. This may involve sending an email to the merchant, or notifying a point of sale, tablet, or other electronic terminal that the merchant will use to receive the order.

The ordering backend can be implemented either entirely within the system 100, or it can be implemented external to it. For example, the system 100 can integrate with an external ordering backend commercial provider such as Olo or Shopify. In such an integration, the execution stage will send requests to update the shopping cart to the external ordering backend and read the state of the shopping cart from the ordering backend to be relayed back.

As part of the response generation stage, the response module 140 may use the results of the previous stages and produces a natural language output, as well as auxiliary output such as visual lists for channels that support other outputs. The response generation may operate in various ways, such as simple templates that have variables that can be evaluated given the output from the previous stages, to sophisticated neural network-based natural language output models.

In the previous example, the output of the previous stages is: Success adding “pizza” with options “large” and “mushroom” to the shopping cart” and Error that “Green onions” is an orphaned option. The response generation may output this in natural language as “I’ve added a large pizza with mushroom to your cart, but green onions aren’t a valid option for pizza.”

Other examples of the kinds of responses that may be generated are as follows. If disambiguation failed to find a unique preferred alternative among multiple ambiguous outputs of the Resolution stage, the user may be prompted with a question. For example, if disambiguation failed between “mushroom” and “mushroom risotto”, the response could be “Did you mean mushroom as a topping on your pizza, or mushroom risotto?” If a validation rule fails, the user may be prompted to make a valid choice. For example, if asked for a “pizza” with both “large” and “small” as options, the user can be asked: “You can’t select more than one size for your pizza. Did you mean large or small?”

The response generation stage may produce other outputs besides the natural language response. For example, if interaction with the system 100 through a channel has a visual interface like Google Assistant or a voice-enabled kiosk, then when the response generation is offering a list of choices to select from, it may also produce a visual list as an auxiliary output that can be displayed to the user.

The system 100 can benefit a merchant by reducing the friction of reordering. To increase the convenience of reordering, the system 100 can offer the following functionality. At the end of a completed order, after the user has successfully checked out, the system 100 can generate an unpredictable random code. The system 100 can then send a message to the user that includes the unpredictable random code and informs the user that they can reorder next time by stating they want to reorder and including the unpredictable random code. For example, the message may read “In order to place the same order next time with one message, just reply “reorder 9382″ and your order will be placed right away.” The next time the user contacts, the system 100 can check whether the message contains the reorder intent and the unpredictable random code, and if so, places the user’s saved order.

Such a process can be well-suited for text channels such as SMS, where the user will see their previous order when opening up the conversation and see the instruction to reorder including the unpredictable random code. The use of the unpredictable random code ensures that an impersonator cannot place an order without having access to the user’s phone or the ability to read the user’s SMS messages. This security is essential since placing the order may charge a saved payment method.

The system 100 can automatically generate the unpredictable random code at the end of the previous order, thereby saving an extra step by not requiring the user to request an unpredictable random code. Since the round-trip time for channels like SMS can be long, often several seconds and sometimes even longer, saving this extra step may greatly improve convenience and reduce the friction of reordering.

In an exemplary embodiment, device 110 may include one or more modules (120, 130 and 140) of the system 100. In another exemplary embodiment, the one or more modules may be based on one or more processor/computer/server external to the device 110. In yet another exemplary embodiment, the one or modules may be based on a combination thereof.

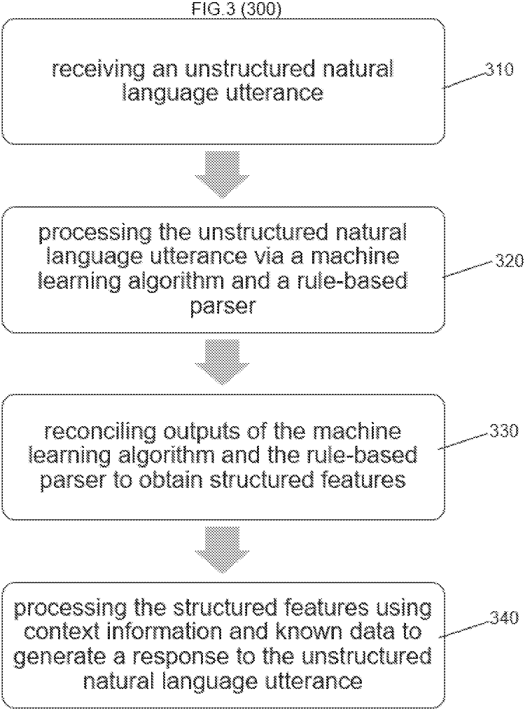

FIG. 3 shows a flowchart of method 300 for generating a response to an unstructured natural language utterance. The method 300 can include a step 310 of receiving an unstructured natural language utterance. Aspects of the step 310 can relate to the previously described device 110 of the system 100. The method 300 can include a step 320 of processing the unstructured natural language utterance via a machine learning algorithm and a rule-based parser. Aspects of the step 320 can relate to the previously described interpretation module 120 of the system 100.

The method 300 can include a step 330 of reconciling outputs of the machine learning algorithm and the rule-based parser to obtain structured features. Aspects of the step 330 can relate to the previously described reconciliation module 130 of the system 100. The method 300 can include a step 340 of processing the structured features using context information and known data to generate a response to the unstructured natural language utterance. Aspects of the step 340 can relate to the previously described response module 140 of the system 100.

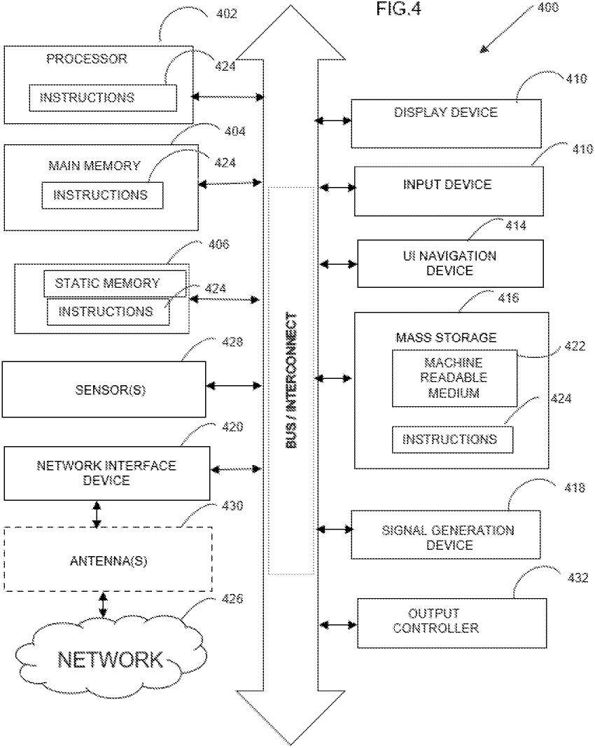

FIG. 4 is a block diagram illustrating an example computing system 400 upon which any one or more of the methodologies (e.g. method 200, 300 or system 100) herein discussed may be run according to an example described herein. Computer system 400 may be embodied as a computing device, providing operations of the components featured in the various figures, including components of the system 100, the device 110, the interpretation module 120, the reconciliation module 130, the response module 140, or any other processing or computing platform or component described or referred to herein.

Example computing system 400 can includes a processor 402 (e.g., a central processing unit (CPU), a graphics processing unit (GPU) or both), a main memory 404 and a static memory 404, which communicate with each other via an interconnect 408 (e.g., a link, a bus, etc.). The computer system 400 may further include a video display unit 410, an alphanumeric input device 412 (e.g., a keyboard), and a user interface (UI) navigation device 415 (e.g., a mouse). In one embodiment, the video display unit 410, input device 412 and UI navigation device 415 are a touch screen display. The computer system 400 may additionally include a storage device 416 (e.g., a drive unit), a signal generation device 418 (e.g., a speaker), an output controller 432, and a network interface device 420 (which may include or operably communicate with one or more antennas 430, transceivers, or other wireless communications hardware), and one or more sensors 428.

The storage device 416 can include a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 constituting machine-readable media.

While the machine-readable medium 422 is illustrated in an example embodiment to be a single medium, the term “machine-readable medium” may include a single medium or multiple medium (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, 4G and 5G, LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 400 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A system for generating a response to an unstructured natural language utterance, the system comprising:
a device configured to receive an unstructured natural language utterance;
an interpretation module configured to process the unstructured natural language utterance via a machine learning algorithm and a rule-based parser;
a reconciliation module configured to reconcile outputs of the machine learning algorithm and the rule-based parser to obtain structured features; and
a response module configured to process the structured features using context information and known data to generate a response to the unstructured natural language utterance.

2. The system of claim 1, wherein the device is configured to receive the unstructured natural language utterance over an audio communication channel or a text communication channel.

3. The system of claim 1, wherein the machine learning algorithm is a neural network.

4. The system of claim 1, wherein the machine learning algorithm is trained on menu data and utterance templates.

5. The system of claim 1, wherein the output of the machine learning algorithm includes an intent of the unstructured natural language utterance, an entity list that provides information regarding the entities involved in the unstructured natural language utterance, and a dependency graph that provides a relationship between words of the unstructured natural language utterance.

6. The system of claim 1, wherein the rule-based parser is configured to use hard-coded rules specific to a merchant associated with the device.

7. The system of claim 1, wherein to process the structured features the response module is configured to search menu data for an entry matching entity in the structured features.

8. The system of claim 7, wherein the response module is configured to resolve ambiguities in the entry.

9. The system of claim 7, wherein the response module is configured to execute a task associated with the entry.

10. The system of claim 1, wherein the response is in form of natural language.

11. A computer-implemented method for generating a response to an unstructured natural language utterance, the method comprising:
receiving an unstructured natural language utterance;
processing the unstructured natural language utterance via a machine learning algorithm and a rule-based parser;
reconciling outputs of the machine learning algorithm and the rule-based parser to obtain structured features; and
processing the structured features using context information and known data to generate a response to the unstructured natural language utterance.

12. The method of claim 11, wherein the receiving is performed over an audio communication channel or a text communication channel.

13. The method of claim 11, wherein the machine learning algorithm is a neural network.

14. The method of claim 11, wherein the machine learning algorithm is trained on menu data and utterance templates.

15. The method of claim 11, wherein the output of the machine learning algorithm includes an intent of the unstructured natural language utterance, an entity list that provides information regarding the entities involved in the unstructured natural language utterance, and a dependency graph that provides a relationship between words of the unstructured natural language utterance.

16. The method of claim 11, wherein the rule-based parser is configured to use hard-coded rules specific to a merchant associated with the device.

17. The method of claim 11, wherein the processing the structured features includes searching menu data for an entry matching entity in the structured features.

18. The method of claim 17, wherein the processing the structured features includes resolving ambiguities in the entry.

19. The method of claim 17, wherein the processing the structured features includes executing a task associated with the entry.

20. The method of claim 11, wherein the response is in form of a natural language.
